(19) United States
(12) Patent Application Publication
(10) Pub. No.: US 2024/0344428 A1
(43) Pub. Date: Oct. 17, 2024

(54) OPTIMIZED DESIGN METHOD AND SYSTEM FOR CARBON DIOXIDE GEOLOGICAL STORAGE PARAMETERS IN DEPLETED GAS RESERVOIR

(71) Applicant: Southwest Petroleum University, Chengdu (CN)

(72) Inventors: Cheng CAO, Chengdu (CN); Zehao XIE, Chengdu (CN); Liehui ZHANG, Chengdu (CN); Yulong ZHAO, Chengdu (CN); Shaomu WEN, Chengdu (CN); Xian PENG, Chengdu (CN); Longxin LI, Chengdu (CN); Ye TIAN, Chengdu (CN); Xiang ZHOU, Chengdu (CN)

(73) Assignee: Southwest Petroleum University, Chengdu (CN)

(21) Appl. No.: 18/412,729

(22) Filed: Jan. 15, 2024

(30) Foreign Application Priority Data
Apr. 12, 2023 (CN) 2023103882101

(51) Int. Cl. E21B 41/00; E21B 43/30

(52) U.S. Cl. CPC E21B 41/0064; E21B 43/30; E21B 2200/20

(57) ABSTRACT

An optimized design method and system for carbon dioxide geological storage parameters of a depleted gas reservoir is provided, including: collecting data of a depleted gas reservoir in which carbon dioxide geological storage is to be carried out, and establishing a numerical simulation model of the depleted gas reservoir; carrying out fitting of production performance history to obtain current state information; simulating and predicting production performance data after carbon dioxide injection into depleted oil and gas reservoirs under different combinations of well pattern parameters and injection parameters using a numerical simulation technology; calculating a parameter value representing a uniform pressure rise according to the production performance data; updating well pattern parameters and injection parameters using a genetic algorithm; repeating above steps until an iterative convergence condition is met; and determining an optimal combination of carbon dioxide injection process parameters according to an output optimal target value.

### CROSS-REFERENCE TO RELATED APPLICATION

This patent application claims the benefit and priority of Chinese Patent Application No. 2023103882101 filed with the China National Intellectual Property Administration on Apr. 12, 2023, the disclosure of which is incorporated by reference herein in its entirety as part of the present application.

### TECHNICAL FIELD

The present disclosure relates to the technical field of carbon dioxide capture, utilization and geological storage (CCUS), in particular to an optimized design method and system for carbon dioxide geological storage parameters of a depleted gas reservoir.

### BACKGROUND

In recent years, the energy field is experiencing an active transition toward a low-carbon, high-efficiency and clean direction. Large-scale injection of carbon dioxide into depleted oil and gas reservoirs to achieve permanent storage of underground carbon dioxide is an important measure to help achieve the goal of “peak carbon dioxide emissions” and “carbon neutrality” in the energy field. Limited by the complex seepage characteristics of carbon dioxide and the special interaction mechanism with rocks, the stored carbon dioxide has a great risk of leakage. By determining a reasonable injection well pattern, an injection mode, and injection-production parameters, the risk of carbon dioxide leakage can be greatly reduced, and the safety and efficiency of carbon dioxide geological storage measures can be guaranteed.

However, most of the existing optimized design methods for carbon dioxide geological storage parameters of a depleted gas reservoir set the process parameters artificially and empirically. Through the numerical simulation method, the effect of carbon dioxide storage under the combination of process parameters is analyzed, but it is difficult to ensure that the optimized results are globally optimal by this method. Moreover, the optimization goal is to unilaterally pursue economic benefits and maximum storage amount, ignoring the influence of leakage on a storage effect, and making it difficult to apply the optimized results to practical engineering practice.

### SUMMARY

An objective of embodiments of the present disclosure is to provide an optimized design method and system for carbon dioxide geological storage parameters of a depleted gas reservoir, which greatly reduces the leakage risk of carbon dioxide stored underground, and further ensures the engineering operability of the optimal combination of process parameters.

To achieve the above objective, the present disclosure provides the following solution.

An optimized design method for carbon dioxide geological storage parameters of a depleted gas reservoir, which is used to optimize well pattern parameters and injection parameters during carbon dioxide injection, and includes following steps:
(1) collecting geological interpretation information, rock data, fluid properties and actual development data of the depleted gas reservoir in which carbon dioxide geological storage is to be carried out, and establishing a numerical simulation model of the depleted gas reservoir;
(2) carrying out fitting of production performance history of the depleted gas reservoir to obtain current state information of the depleted gas reservoir;
(3) simulating and predicting production performance data after carbon dioxide injection into depleted oil and gas reservoirs under different combinations of well pattern parameters and injection parameters through using a numerical simulation technology;
(4) calculating a parameter value representing a uniform pressure rise according to the production performance data;
(5) updating the well pattern parameters and the injection parameters through using a genetic algorithm;
(6) repeating steps (3)-(5) until an iterative convergence condition is met; and
(7) determining an optimal combination of carbon dioxide injection process parameters according to an output optimal target value.

Optionally, the collecting geological data, rock fluid data, and actual development history data specifically include:
collecting geological interpretation information, including single well development data (including well location coordinates, kelly bushing, vertical depth, inclined depth, well deviation data, etc.), single well stratification data, well logging curves, division of sedimentary facies, seismic data, seismic level data and fault data; rock data, including reservoir lithology, mineral composition, pore type, cementation type, porosity and permeability physical properties (porosity and permeability), sensitivity and rock compressibility; fluid properties, including formation fluid component content, crude oil density, viscosity, dissolved gas-oil ratio and other high-pressure physical properties, density, viscosity and PVT properties of gas components, complete analysis data of formation water quality (including density, ion concentration, degree of mineralization, PH value, etc.), oil-water/oil-gas/gas-liquid relative permeability curves; and actual development data, including formation temperature, formation pressure distribution, development timetable, daily oil production, daily gas production, daily water production and bottom hole flowing pressure report.

Optionally, the carrying out fitting of production performance history of the depleted gas reservoir to obtain current state information of the depleted gas reservoir specifically includes:
setting a working system for each well in the depleted gas reservoir according to production data, the working system including but not limited to constant liquid production, constant bottom hole flowing pressure and constant gas production; fitting the actual production data such as oil production, gas production, water production and bottom hole flowing pressure; and outputting the current state information of the depleted gas reservoir after fitting, including an oil/gas/water saturation field, pressure distribution and temperature distribution.

Optionally, the simulating and predicting production performance data after carbon dioxide injection into depleted oil and gas reservoirs under different combinations of well pattern parameters and injection parameters specifically includes:
calculating the production performance data under combinations of well pattern parameters and injection parameters, the production performance data including a change of pressure with time, and a carbon dioxide storage amount, the storage amount being a sum of a structural storage amount, a residual phase storage amount, a dissolution storage amount and a mineralization storage amount, where the well pattern parameters determine whether existing wells in the depleted gas reservoir are used as injection wells in a carbon dioxide injection process without additional cost, that is, without adding new wells, and the injection parameters include an injection mode (including continuous injection, intermittent injection and gas-water alternating injection), a gas injection rate of each well, a water injection rate of each well and intermittent injection time.

Optionally, the calculating a parameter value representing a uniform pressure rise specifically includes:
calculating a pressure value of each grid in a model at a final time step to obtain an average pressure value of the model at the time step, and calculating a standard deviation between the pressure value of each grid and the average pressure value of the model to obtain a standard pressure difference of the model at the time step, so as to obtain the parameter value representing the uniform pressure rise at the time step, which is a parameter value representing the uniform pressure rise of the depleted gas reservoir;
where the average pressure value of the model at the time step is calculated by using a following formula:

$$\overline{{P}_{n}} = {{\sum }^{a , b , c}}_{i = 1 , j = 1 , k = 1} {P}_{i , j , k}$$

where a is a number of grids in an i-th direction, b is a number of grids in a j-th direction, c is a number of grids in a k-th direction, P_{i, j, k} is a pressure value of each grid in the model, and P̅ₙ̅ is an average pressure value of the model at the time step;
the standard pressure difference of the model at the current time step is calculated by using a following formula:

$$S {D}_{n} = \sqrt{\frac{{\sum }_{i = 1 , j = 1 , k = 1}^{a , b , c} {( {P}_{i , j , k} - \overline{{P}_{n}} )}^{2}}{m}}$$

where SDₙ is a standard pressure deviation of the model at the current time step, and m is a number of grids in the model.

Optionally, the updating the well pattern parameters and the injection parameters through using a genetic algorithm specifically includes:
randomly generating a series of combinations of well pattern parameters and injection parameters within a range of constraints, obtaining objective function values corresponding to all combinations of parameters using the numerical simulation model, and initializing a population through each combination of well pattern parameters and injection parameters and an objective function value corresponding to each combination to obtain a parent population;
where an objective function is the parameter value representing the uniform pressure rise of the depleted gas reservoir; a combination of well pattern parameters and injection parameters includes on-off state, gas injection rate, water injection rate, well opening time and well closing time of each well; the constraints include a 0-1 constraint on the on-off state of each well, upper and lower limit constraints on the gas injection rate, the water injection rate, the well opening time and the well closing time, and a constraint that gas injection is stopped when a formation pressure reaches 80% of a rock fracture pressure (pressure threshold), and
obtaining a new offspring after subjecting the parent population to crossover and mutation, calculating a fitness function of individuals in the offspring by using the numerical simulation model, the fitness function using the parameter value representing the uniform pressure rise of the depleted gas reservoir, comparing fitness function values of individuals in the parent population and the individuals in the offspring, and updating the parent population to obtain a new parent population.

Optionally, repeating above until an iterative convergence condition is met specifically includes:
repeating steps (3)-(5) if the iterative convergence condition is not met; and ending calculation and proceeding to step (7) if the iterative convergence condition is met, where the iterative convergence condition is a maximum number of iterations of the algorithm, that is, a maximum number of operations of the numerical simulation model.

Optionally, the determining an optimal combination of carbon dioxide injection process parameters according to an output optimal target value in step (7) includes:
after the iterative convergence condition is met, outputting an individual with a global optimal target value, and obtaining the on-off state, the gas injection rate, the water injection rate, the well opening time and the well closing time of each well through decoding, where a combination of above parameters is the optimal combination of carbon dioxide injection process parameters.

Corresponding to the optimized design method for carbon dioxide geological storage parameters of the depleted gas reservoir, the present disclosure further provides an optimized design system for carbon dioxide geological storage parameters of a depleted gas reservoir, which is used for optimizing well pattern parameters and injection parameters in a carbon dioxide injection process, and includes:
a collecting module, including:
a collecting sub-module, configured to collect geological interpretation information, rock data, fluid properties and actual development data of the depleted gas reservoir in which carbon dioxide geological storage is to be carried out, where the geological interpretation information includes single well development data (including well location coordinates, kelly bushing, vertical depth, inclined depth, well deviation data, etc.), single well stratification data, well logging curves, division of sedimentary facies, seismic data, seismic level data and fault data; the rock data includes reservoir lithology, mineral composition, pore type, cementation type, porosity and permeability physical properties (porosity and permeability), sensitivity and rock compressibility; the fluid properties include formation fluid component content, crude oil density, viscosity, dissolved gas-oil ratio and other high-pressure physical properties, density, viscosity and PVT properties of gas components, complete analysis data of formation water quality (including density, ion concentration, degree of mineralization, PH value, etc.), oil-water/oil-gas/gas-liquid relative permeability curves; the actual development data includes formation temperature, formation pressure distribution, development timetable, daily oil production, daily gas production, daily water production and bottom hole flowing pressure report;
a building sub-module, configured to establish a numerical simulation model of the depleted gas reservoir;
an obtaining module, including:
a history fitting sub-module, configured to carry out fitting of production performance history of the depleted gas reservoir, where the fitting of production performance history includes fitting the actual production data such as oil production, gas production, water production and bottom hole flowing pressure;
an obtaining sub-module, configured to obtain current state information of the depleted gas reservoir, where the current state information of the depleted gas reservoir includes an oil/gas/water saturation field, pressure distribution and temperature distribution;
a predicting module, configured to simulate and predict production performance data after carbon dioxide injection into depleted oil and gas reservoirs under different combinations of well pattern parameters and injection parameters through using the numerical simulation technology, where the production performance data includes a change of pressure with time, and a carbon dioxide storage amount, in which the storage amount being a sum of a structural storage amount, a residual phase storage amount, a dissolution storage amount and a mineralization storage amount;
a calculating module, configured to calculate a parameter value representing a uniform pressure rise according to the production performance data;
an updating module, configured to update the well pattern parameters and the injection parameters through using a genetic algorithm;
an iteration module, configured to iteratively calculate a parameter value representing a uniform pressure rise under different combinations of parameters until an iterative convergence condition is met; and
a determining module, configured to determine an optimal combination of carbon dioxide injection process parameters.

According to the specific embodiment provided by the present disclosure, the present disclosure discloses the following technical effects.

The present disclosure provides an optimized design method and system for carbon dioxide geological storage parameters of a depleted gas reservoir. The method includes: collecting geological interpretation information, rock data, fluid properties and actual development data of the depleted gas reservoir in which carbon dioxide geological storage is to be carried out, and establishing a numerical simulation model of the depleted gas reservoir; carrying out fitting of production performance history of the depleted gas reservoir to obtain current state information of the depleted gas reservoir; using a numerical simulation technology to simulate and predict production performance data after carbon dioxide injection into depleted oil and gas reservoirs under different combination of well pattern parameters and injection parameters; calculating a parameter value representing a uniform pressure rise according to the production performance data; using a genetic algorithm to update the well pattern parameters and injection parameters; repeating the above steps until an iterative convergence condition is met; and determining an optimal combination of carbon dioxide injection process parameters according to an output optimal target value. According to the present disclosure, a scheme with a minimum risk can be obtained, and the problem of difficult practical application is avoided.

### BRIEF DESCRIPTION OF THE DRAWINGS

In order to explain the embodiments of the present disclosure or the technical scheme in the prior art more clearly, the drawings needed in the embodiments will be briefly introduced hereinafter. Obviously, the drawings in the following description are only some embodiments of the present disclosure. Other drawings can be obtained according to these drawings without paying creative labor for those skilled in the art.

FIG. 1 is a flow chart of an optimized design method for carbon dioxide geological storage parameters of a depleted gas reservoir according to Embodiment 1 of the present disclosure.

FIG. 2 is a schematic diagram of a numerical simulation model in the method according to Embodiment 1 of the present disclosure.

FIG. 3 is a diagram of a fitting result of production performance history in the method according to Embodiment 1 of the present disclosure.

FIG. 4A is a pressure information diagram of a first sub-layer of a current formation of a depleted gas reservoir in the method according to Embodiment 1 of the present disclosure.

FIG. 4B is a pressure information diagram of a second sub-layer of a current formation of a depleted gas reservoir in the method according to Embodiment 1 of the present disclosure.

FIG. 4C a pressure information diagram of a third sub-layer of a current formation of a depleted gas reservoir in the method according to Embodiment 1 of the present disclosure.

FIG. 5 is an iterative graph of a parameter value representing a uniform pressure rise with the number of numerical simulations in the method according to Embodiment 1 of the present disclosure.

FIG. 6A is a pressure information diagram of the first sub-layer at the end of carbon dioxide injection in a scheme corresponding to a minimum parameter value representing a uniform pressure rise in the method according to Embodiment 1 of the present disclosure.

FIG. 6B is a pressure information diagram of the second sub-layer at the end of carbon dioxide injection in a scheme corresponding to a minimum parameter value representing a uniform pressure rise in the method according to Embodiment 1 of the present disclosure.

FIG. 6C is a pressure information diagram of the third sub-layer at the end of carbon dioxide injection in a scheme corresponding to a minimum parameter value representing a uniform pressure rise in the method according to Embodiment 1 of the present disclosure.

FIG. 7 is a schematic structural diagram of an optimized design system for carbon dioxide geological storage parameters of a depleted gas reservoir according to Embodiment 2 of the present disclosure.

### DETAILED DESCRIPTION OF THE EMBODIMENTS

The technical scheme in the embodiment of the present disclosure will be clearly and completely described with reference to the attached drawings hereinafter. Obviously, the described embodiments are only some of the embodiments of the present disclosure, rather than all of the embodiments. Based on the embodiments in the present disclosure, all other embodiments obtained by those skilled in the art without creative labor belong to the scope of protection of the present disclosure.

At present, three methods are mainly used to optimize engineering parameters.

(1) Scheme comparison and selection: different engineering parameter combinations are artificially set, a physical simulation or numerical simulation means is used to evaluate the development effect under different parameter combinations, and by comparison, the process parameter combination with the best development effect is selected as the optimal scheme. This method is a comparison and selection of parameter, which makes it difficult to obtain the global optimal scheme, and the optimized results are unconvincing.

(2) The parameters are optimized with the goal of the maximum economic net present value in conjunction with the optimization algorithm. An optimization mathematical model is constructed with the goal of the maximum economic net present value, and the optimal scheme is obtained by combining the optimization algorithm with numerical simulation or physical simulation. Although this method can obtain the global optimal scheme, this method unilaterally pursues the maximization of economic benefits and ignores the operability in engineering, thus causing the optimized results to be unable to guide the actual engineering application.

(3) A proxy model is built to accelerate the optimization process. Compared with the method (2), only the proxy model is built in place of the physical simulation or numerical simulation, which accelerates the optimization process. However, the optimal scheme optimized by this method still has no engineering operability and is difficult to be applied to engineering practice. Therefore, it is of great significance to put forward an optimal design method for carbon dioxide geological storage parameters of a depleted gas reservoir, which can guide practical engineering practice and obtain the global optimal scheme.

The present disclosure aims to provide an optimized design method and system for carbon dioxide geological storage parameters of a depleted gas reservoir, which reduces the risk degree of the optimal process parameter combination scheme, thereby ensuring the operability of the optimal process parameter combination scheme.

In order to make the above objects, features and advantages of the present disclosure more obvious and understandable, the present disclosure will be further described in detail in conjunction with the attached drawings and specific embodiments.

### Embodiment 1

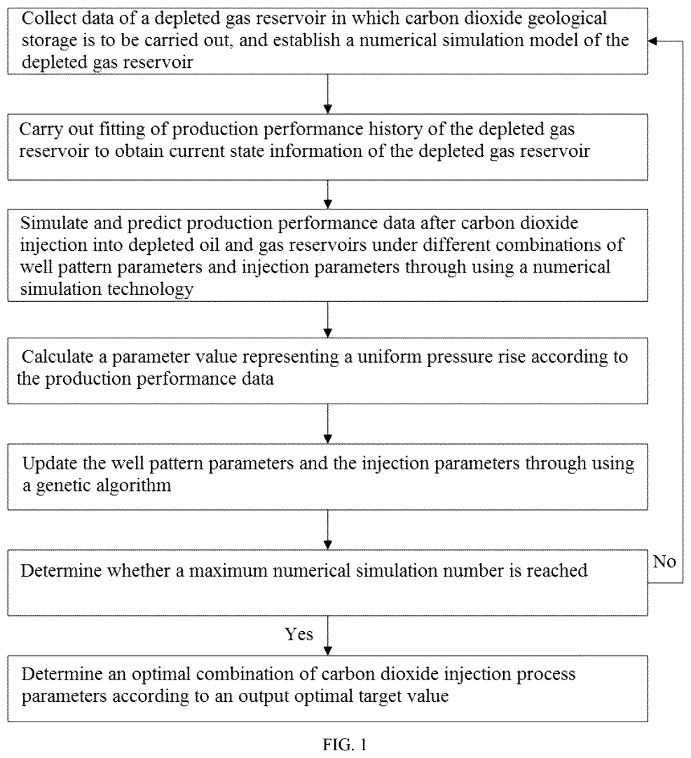

This embodiment provides an optimized design method for carbon dioxide geological storage parameters of a depleted gas reservoir, as shown in the flowchart in FIG. 1. The optimized design method for carbon dioxide geological storage parameters includes following steps S1-S7.

In step S1, geological interpretation information, rock data, fluid properties and actual development data of the depleted gas reservoir in which carbon dioxide geological storage is to be carried out are collected, and a numerical simulation model of the depleted gas reservoir is established. Step S1 specifically includes following steps S11-S14.

In step S11, geological interpretation information is collected, which includes single well development data (including well location coordinates, kelly bushing, vertical depth, inclined depth, well deviation data, etc.), single well stratification data, well logging curves, division of sedimentary facies, seismic data, seismic level data and fault data.

In step S12, rock data is collected, which includes reservoir lithology, mineral composition, pore type, cementation type, porosity and permeability physical properties (porosity and permeability), sensitivity and rock compressibility.

In step S13, fluid properties are collected, which includes formation fluid component content, crude oil density, viscosity, dissolved gas-oil ratio and other high-pressure physical properties, density, viscosity and PVT properties of gas components, complete analysis data of formation water quality (including density, ion concentration, degree of mineralization, PH value, etc.), oil-water/oil-gas/gas-liquid relative permeability curves.

In step S14, actual development data is collected, which includes formation temperature, formation pressure distribution, development timetable, daily oil production, daily gas production, daily water production and bottom hole flowing pressure report.

In step S2, production performance history of the depleted gas reservoir is fitted to obtain current state information of the depleted gas reservoir. Step S2 specifically includes following steps S21-S23.

In step S21, a working system is set for each well in the depleted gas reservoir according to production data, the working system including but not limited to constant liquid production, constant bottom hole flowing pressure and constant gas production.

In step S22, the actual production data such as oil production, gas production, water production and bottom hole flowing pressure is fitted.

In step S23, current state information of the depleted gas reservoir is output after fitting, which includes an oil/gas/water saturation field, pressure distribution and temperature distribution.

In step S3, numerical simulation technology is used to simulate and predict production performance data after carbon dioxide injection into depleted oil and gas reservoirs under different combinations of well pattern parameters and injection parameters. Step S3 specifically includes following steps S31-S33.

In step S31, the well pattern parameters determine whether the existing wells in the depleted gas reservoir are used as injection wells in the carbon dioxide injection process without additional cost, that is, without adding new wells.

In step S32, the injection parameters include an injection mode (including continuous injection, intermittent injection and gas-water alternating injection), a gas injection rate of each well, a water injection rate of each well and intermittent injection time.

In step S33, production performance data is calculated under combinations of well patterns and injection parameters, the production performance data includes a change of pressure with time, and a carbon dioxide storage amount, in which the storage amount is a sum of a structural storage amount, a residual phase storage amount, a dissolution storage amount and a mineralization storage amount.

In step S4, a parameter value representing a uniform pressure rise is calculated according to the production performance data. Step S4 specifically includes the following step S41.

In step S41, a pressure value of each grid in a model at a final time step is calculated to obtain an average pressure value of the model at the time step, and a standard deviation between the pressure value of each grid and the average pressure value of the model is calculated to obtain a standard pressure difference of the model at the time step, so as to obtain the parameter value representing the uniform pressure rise at the time step, which is a parameter value representing the uniform pressure rise of the depleted gas reservoir.

In this embodiment, the average pressure value of the model at the time step is calculated according to the following formula:

$$\overline{{P}_{n}} = {{\sum }^{a , b , c}}_{i = 1 , j = 1 , k = 1} {P}_{i , j , k}$$

where: a is the number of grids in an i-th direction, b is the number of grids in a j-th direction, c is the number of grids in a k-th direction, P_{i, j, k} is a pressure value of each grid in the model, and P̅ₙ̅ is an average pressure value of the model at the time step.

In this embodiment, the standard pressure difference of the model at the current time step is calculated according to the following formula:

$$S {D}_{n} = \sqrt{\frac{{\sum }_{{{i = 1 , j = 1 , k = 1}_{}}^{}}^{a , b , c} {( {P}_{i , j , k} - \overline{{P}_{n}} )}^{2}}{m}}$$

where: SDₙ is a standard pressure deviation of the model at the current time step, and m is the number of grids in the model.

In step S5, a genetic algorithm is used to update the well pattern parameters and the injection parameters. Step S5 specifically includes following steps S51-S53.

In step S51, a series of combinations of well pattern parameters and injection parameters are randomly generated within the range of constraints, objective function values corresponding to all combinations of parameters is obtained using the numerical simulation model; and a population is initialized through each combination of well pattern parameter and injection parameter and an objective function value corresponding to each combination to obtain a parent population.

In step S52, in this embodiment, an objective function is the parameter value representing the uniform pressure rise of the depleted gas reservoir; a combination of well pattern parameters and injection parameters includes on-off state, gas injection rate, water injection rate, well opening time and well closing time of each well; the constraints include a 0-1 constraint on the on-off state of each well, upper and lower limit constraints on the gas injection rate, the water injection rate, the well opening time and the well closing time, and a constraint that gas injection is stopped when the formation pressure reaches 80% of a rock fracture pressure (pressure threshold).

In step S53, after the parent population is subjected to crossover and mutation, a new offspring is obtained, a fitness function of individuals in the offspring is calculated by using the numerical simulation model, the fitness function uses the parameter value representing the uniform pressure rise of the depleted gas reservoir, fitness function values of individuals in the parent population and the individuals in the offspring are compared, and the parent population is updated to obtain a new parent population.

In step S6, the above steps S3-S5 are repeated until an iterative convergence condition is met. Step S6 specifically includes following step S61.

In step S61, the iterative convergence condition is a maximum number of iterations of the algorithm, that is, a maximum number of operations of the numerical simulation model; if the iterative convergence condition is not met, steps S3-S5 are repeated; and if the iterative convergence condition is met, calculation is ended, and the flow proceeds to Step S7.

In step S7, an optimal combination of carbon dioxide injection process parameters is determined according to an output optimal target value. Step S7 specifically includes following step S71.

In step S71, after the iterative convergence condition is met, the individual with a global optimal target value is output, and the on-off state, the gas injection rate, the water injection rate, the well opening time and the well closing time of each well are obtained through decoding, in which combination of the above parameters is the optimal combination of carbon dioxide injection process parameters.

The present disclosure takes a well group for carbon dioxide geological storage of an actual depleted gas reservoir in an oil field as an example, and provides the specific steps 1-7 of the optimized design method for carbon dioxide geological storage parameters of a depleted gas reservoir in the practical application.

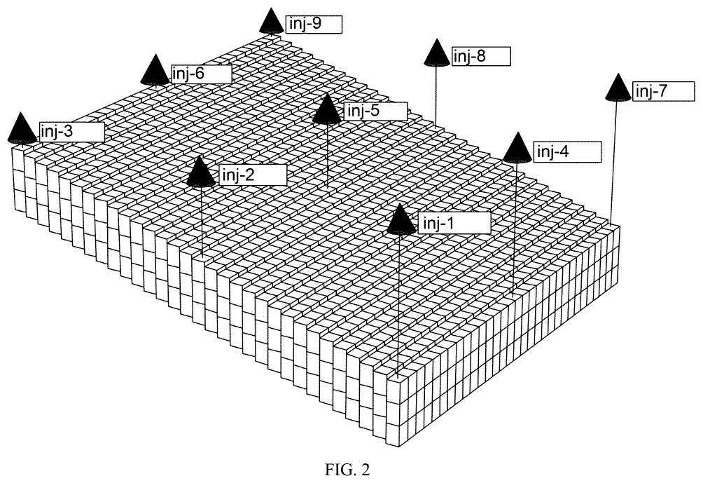

Step 1 corresponds to S1 described above, in which geological interpretation information, rock data, fluid properties and actual development data of the depleted gas reservoir in which carbon dioxide geological storage is to be carried out are collected, and a numerical simulation model of the depleted gas reservoir is established. Specifically, in this example, based on the collected geological interpretation information, rock data, fluid properties and actual development data of the depleted gas reservoir, information such as the top depth, the porosity, the permeability, the net-to-gross ratio, the saturation, the gas components, relative permeability curves, the gas reservoir well location, and production data of each well is obtained. The numerical simulation model of the depleted gas reservoir is further established. The basic parameters of the numerical simulation model of the depleted gas reservoir are shown in Table 1, the gas composition information is shown in Table 2, and the numerical simulation model is shown in FIG. 2.

TABLE 1
Table showing Basic Parameters of
the Numerical Simulation Model

| Geological parameter | Unit | Parameter value |
|---|---|---|
| Average top depth | m | 2077.915 |
| Average net-to-gross ratio | — | 0.3 |
| Average porosity | — | 0.16 |
| Average permeability | 10⁻³ μm² | 9.81 |
| Oil reservoir temperature | ° C. | 98.9 |

TABLE 2
Table showing Gas Components

| Component name | Component content |
|---|---|
| CO₂ | 0.00343 |
| N₂ | 0.01971 |
| CH₄ | 0.16739 |
| C₂HtoNC₄ | 0.1144 |
| IC₅toC₇ | 0.06202 |
| C₈toC₁₃ | 0.25472 |
| C₁₄toC₁₉ | 0.14337 |
| C₂₀toC₃₀ | 0.14795 |
| C₃₁toC₃₆ | 0.08701 |

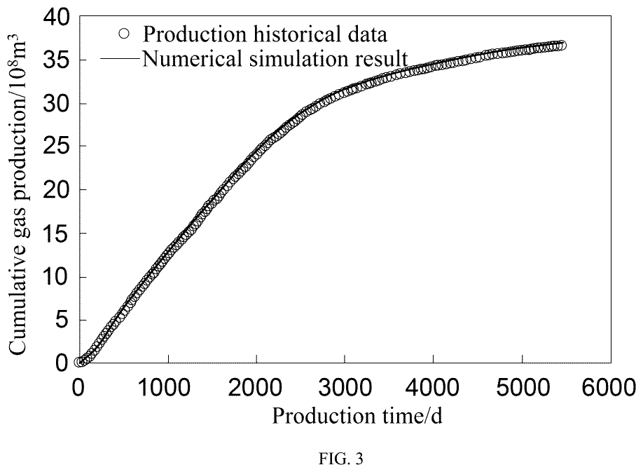

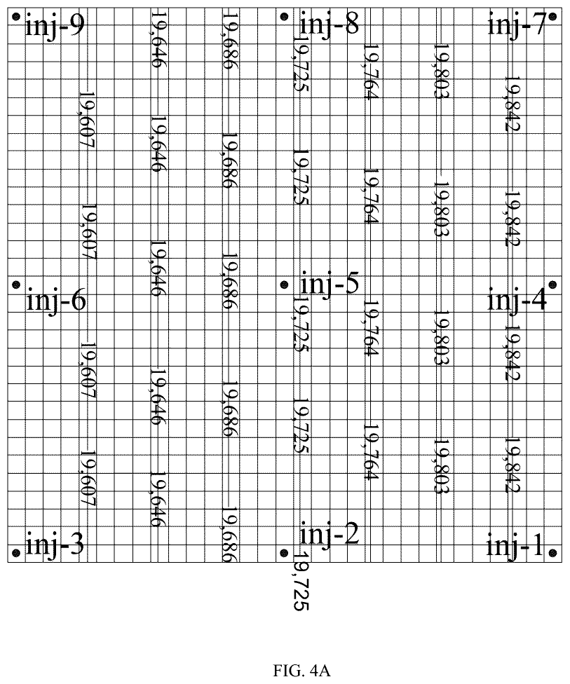

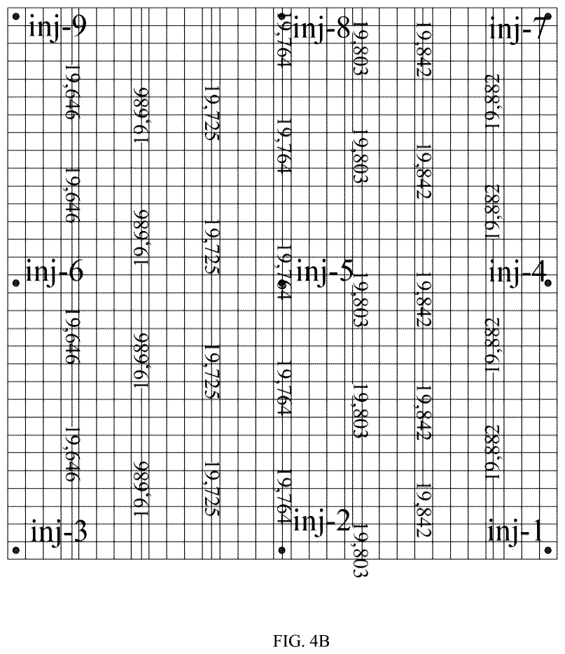

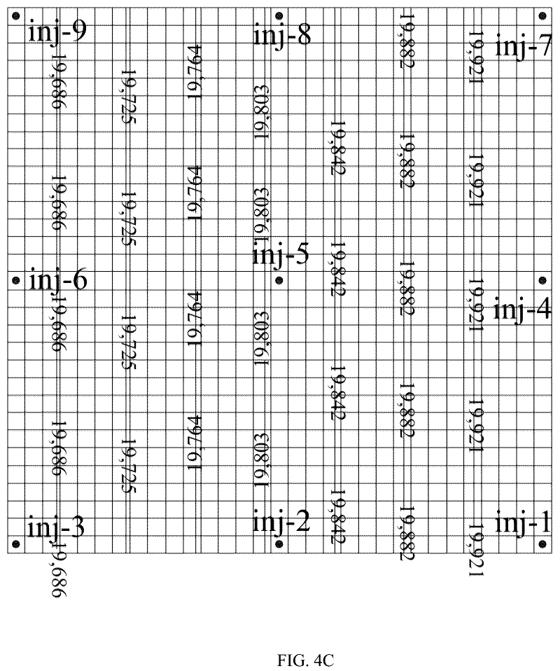

Step 2 corresponds to S2 described above, in which fitting of production performance history of the depleted gas reservoir is carried out to obtain current state information of the depleted gas reservoir. Specifically, in this example, based on nine actual production wells of the depleted gas reservoir, the working system is set as constant fluid production, the compressibility of crude oil in this block is 1.522, the compressibility of gas is 0.0032, and the compressibility of water is 1. The historical gas production of the depleted gas reservoir is fit, and then the current pressure distribution of the depleted gas reservoir is output. The cumulative gas production of the depleted gas reservoir is fit as shown in FIG. 3, and the current formation pressure distribution of each sub-layer is shown in FIG. 4A-4C.

Step 3 corresponds to S3 described above, in which numerical simulation technology is used to simulate and predict production performance data after carbon dioxide injection into depleted oil and gas reservoirs under different combination of well pattern and injection parameters. Specifically, in this example, all of the existing 9 wells are set as injection wells, the injection speed is set to 10,000 m³/d in a continuous injection mode, and the injection is stopped when the formation pressure reaches 80% of the formation fracture pressure. The grid pressure of the model at the time of stopping injection is counted. Continuing to simulate for 200 years after stopping injection, the carbon dioxide storage is counted, and a sum of carbon dioxide storage amount including a structural storage amount, a residual phase storage amount, a dissolution storage amount and a mineralization storage amount is calculated.

Step 4 corresponds to S4 described above, in which a parameter value representing a uniform pressure rise is calculated according to the production performance data. In this example, the average pressure is calculated according to the following formula:

$$\overline{{P}_{n}} = {{\sum }_{i = 1 , j = 1 , k = 1}}^{a , b , c} {P}_{i , j , k}$$

where: a is the number of grids in an i-th direction, b is the number of grids in a j-th direction, c is the number of grids in a k-th direction, P_{i, j, k} is a pressure value of each grid in the model, and P̅ₙ̅ is an average pressure value of the model at the time step.

In this example, the standard pressure difference of the model is calculated according to the following formula:

$$S {D}_{n} = \sqrt{\frac{{{\sum }_{i = 1 , j = 1 , k = 1}}^{a , b , c} {( {P}_{i , j , k} - \overline{{P}_{n}} )}^{2}}{m}}$$

where: SDₙ is a standard pressure deviation of the model at the current time step, and m is the number of grids in the model.

Using the average pressure calculation formula, it is concluded that the formation average pressure is 32.16 MPa at the end of carbon dioxide injection in the depleted gas reservoir by, and then using the pressure standard deviation calculation formula, it is concluded that the value representing the uniform pressure rise of the depleted gas reservoir in this scheme is 424.90.

Step 5 corresponds to S5 described above, in which a genetic algorithm is used to update the well pattern and injection parameters. In order to reduce the leakage risk of carbon dioxide in the process of geological storage in the depleted gas reservoir, the value representing the uniform pressure rise is used an optimized objective function, and the optimized objective is to minimize the value representing the uniform pressure rise. The well pattern parameter is an on-off state of each well, and the injection parameter is the gas injection rate of each well. The constraints include 0-1 constraint on the on-off state of each well, upper and lower limit constraints on the gas injection rate, and the constraint that gas injection is stopped when the formation pressure reaches 80% of a rock fracture pressure (pressure threshold). A genetic algorithm is used to update the well pattern and injection parameters, which needs to set the basic control parameters of the genetic algorithm. In this example, the optimized parameter combination is shown in Table 3, and the genetic algorithm control parameters are shown in Table 4.

TABLE 3
Optimized Parameter Combination and Constraints

| Optimized parameter name | Unit | Value range |
|---|---|---|
| On-off state of each well | — | 0 or 1 |
| Gas injection rate of each well | m³/d | 5000-20000 |

TABLE 4
Control Parameters of a Genetic Algorithm

| Control parameter type | Parameter value |
|---|---|
| Variation rate | 0.05 |
| Crossover rate | 0.5 |
| Number of populations | 20 |
| Maximum number of iteration steps | 25 |

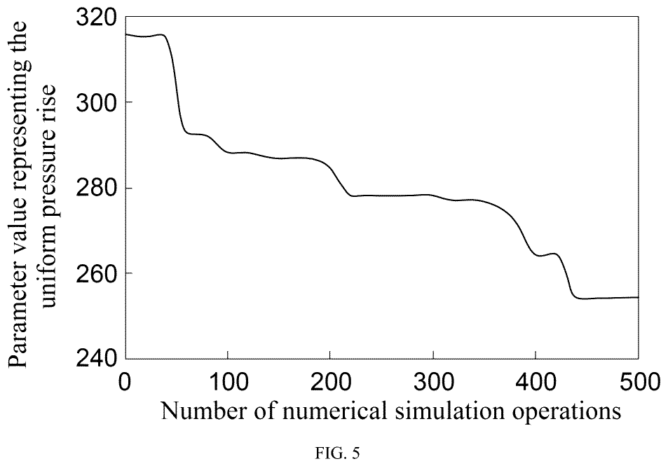

Step 6 corresponds to S6 described above, in which steps 1-6 are repeated until an iterative convergence condition is met. In this example, the iterative convergence condition is to reach the set maximum number of numerical simulation operations. This optimization process operates 500 numerical simulations in total, and then jumps to step 7 after reaching the maximum number of numerical simulation operations. In the optimization process, the iterative curve of the parameter value representing the uniform pressure rise with the increase of numerical simulations is shown in FIG. 5.

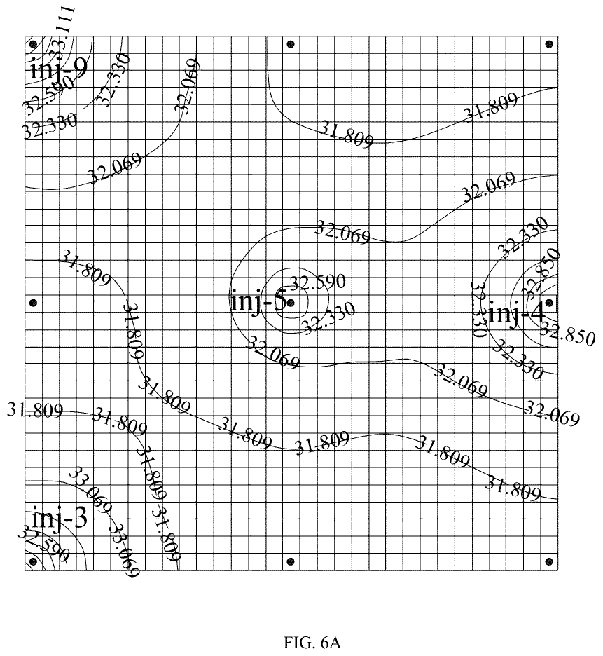

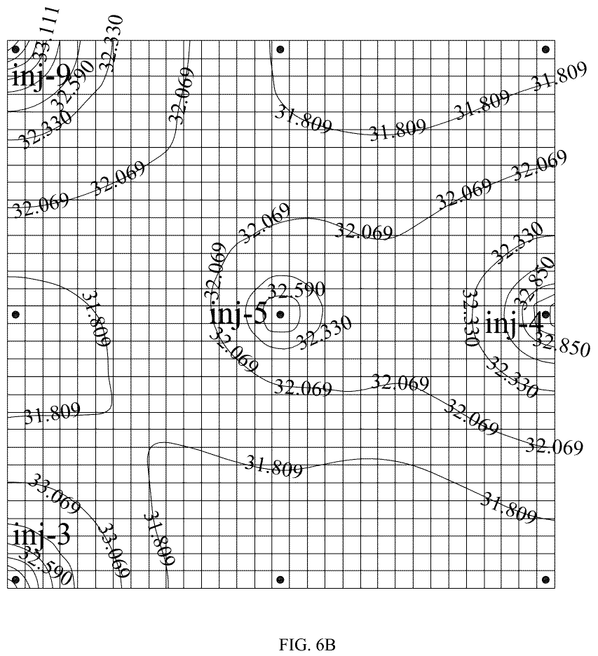

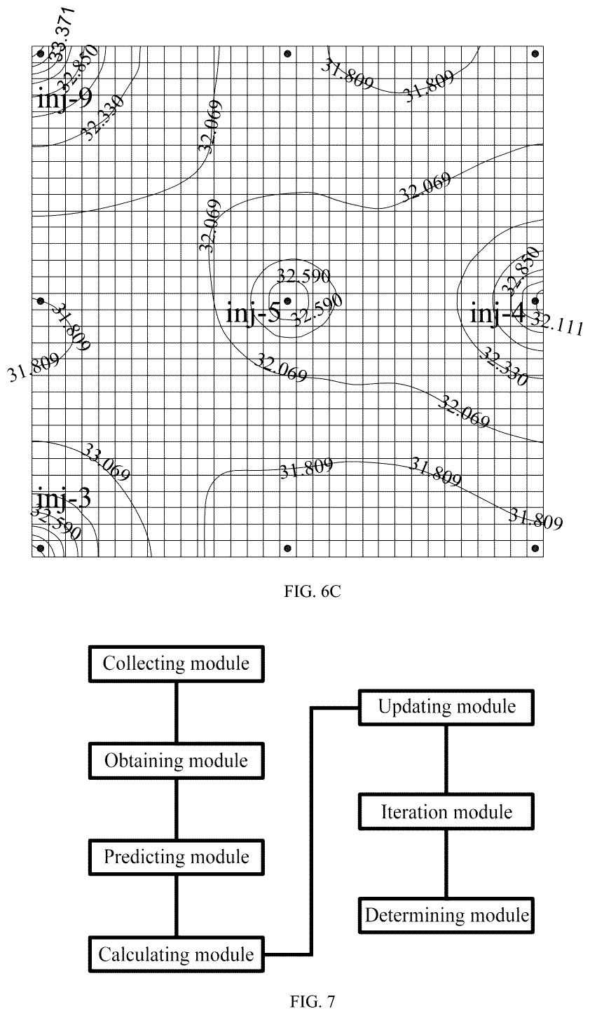

Step 7 corresponds to S7 described above, in which an optimal combination of carbon dioxide injection process parameters is determined according to an output optimal target value. The minimum value of the parameter representing the uniform pressure rise is 254.16, and the carbon dioxide injection can reach 157.31×10⁴ m³. The corresponding optimal combination of process parameters is shown in Table 5. The formation pressure information diagram at the end of carbon dioxide injection is shown in FIG. 6A-6C.

TABLE 5
Optimum Combination of Carbon Dioxide
Injection Process Parameters

| Well name | On-off state | Injection rate/(m³/d) |
|---|---|---|
| Injection well 1 | closing well | — |
| Injection well 2 | closing well | — |
| Injection well 3 | opening well | 5076.28 |
| Injection well 4 | opening well | 8325.73 |
| Injection well 5 | opening well | 7048.96 |
| Injection well 6 | closing well | — |
| Injection well 7 | closing well | — |
| Injection well 8 | closing well | — |
| Injection well 9 | opening well | 5051.87 |

In this embodiment, in step 2, fitting of production performance history of the depleted gas reservoir is carried out to obtain current state information of the depleted gas reservoir, effectively avoiding the problem that the numerical simulation cannot accurately represent the characteristics of the depleted gas reservoir which results in low accuracy of the numerical simulation results.

In step 4, the uniform pressure rise is the goal, and the maximum formation pressure is limited to not exceed 80% of the fracturing pressure. Compared with the existing optimization technology with the goal of maximizing the economic net present value or the carbon dioxide injection amount, the present disclosure can inject the most carbon dioxide with the lowest risk of carbon dioxide leakage, and the optimized results can be applied to the actual carbon dioxide geological storage project.

In step 5, a genetic algorithm is used to update the well pattern and injection parameters. When the iterative convergence condition is not met, steps 3-5 are repeated. When the condition is met, the content of step 7 is executed, so that the globally optimal combination of well pattern and injection parameters can be found in the search space of variables. Compared with the injection scheme determined artificially by experience on site, the present disclosure ensures that the optimized result is the global optimal scheme, and can provide rapid and scientific technical support for on-site carbon dioxide geological storage decision.

### Embodiment 2

Corresponding to the optimized design method for carbon dioxide geological storage parameters of the depleted gas reservoir according to Embodiment 1, this embodiment provides an optimized design system for carbon dioxide geological storage parameters of a depleted gas reservoir, as shown in FIG. 7, including:
a collecting module, including:
a collecting sub-module, configured to collect geological interpretation information, rock data, fluid properties and actual development data of the depleted gas reservoir in which carbon dioxide geological storage is to be carried out, where the geological interpretation information includes single well development data (including well location coordinates, kelly bushing, vertical depth, inclined depth, well deviation data, etc.), single well stratification data, well logging curves, division of sedimentary facies, seismic data, seismic level data and fault data; the rock data includes reservoir lithology, mineral composition, pore type, cementation type, porosity and permeability physical properties (porosity and permeability), sensitivity and rock compressibility; the fluid properties include formation fluid component content, crude oil density, viscosity, dissolved gas-oil ratio and other high-pressure physical properties, density, viscosity and PVT properties of gas components, complete analysis data of formation water quality (including density, ion concentration, degree of mineralization, PH value, etc.), oil-water/oil-gas/gas-liquid relative permeability curves; the actual development data includes formation temperature, formation pressure distribution, development timetable, daily oil production, daily gas production, daily water production and bottom hole flowing pressure report;
a building sub-module, configured to establish a numerical simulation model of the depleted gas reservoir;
an obtaining module, including:
a history fitting sub-module, configured to carry out fitting of production performance history of the depleted gas reservoir, where the fitting of production performance history includes fitting the actual production data such as oil production, gas production, water production and bottom hole flowing pressure;
an obtaining sub-module, configured to obtain current state information of the depleted gas reservoir, where the current state information of the depleted gas reservoir includes an oil/gas/water saturation field, pressure distribution and temperature distribution;
a predicting module, configured to simulate and predict production performance data after carbon dioxide injection into depleted oil and gas reservoirs under different combinations of well pattern parameters and injection parameters through using the numerical simulation technology, where the production performance data includes a change of pressure with time, and a carbon dioxide storage amount, in which the storage amount being a sum of a structural storage amount, a residual phase storage amount, a dissolution storage amount and a mineralization storage amount;
a calculating module, configured to calculate a parameter value representing a uniform pressure rise according to the production performance data;
an updating module, configured to update the well pattern parameters and the injection parameters through using a genetic algorithm;
an iteration module, configured to iteratively calculate a parameter value representing a uniform pressure rise under different parameter combinations until an iterative convergence condition is met; and
a determining module, configured to determine an optimal combination of carbon dioxide injection process parameters.

The program part in technology can be regarded as a “product” or an “article of manufacture” in the form of an executable code and/or related data, which is participated in or realized by computer-readable media. Tangible, permanent storage media can include a memory or storage used by any of a computer, a processor, or a similar device or a related module, for example, various semiconductor memories, tape drives, disk drives, or similar devices that can provide storage functions for software.

All software or a part thereof may sometimes communicate through a network, such as the Internet or other communication networks. Such communication can load software from one computer device or processor to another, for example, a hardware platform loaded into a computer environment from a server or a host computer of a video target detection device, or other computer environments that realize the system, or a system with similar functions related to providing information needed for target detection. Therefore, another medium that can transmit software elements can also be used as a physical connection between local devices, such as light waves, electric waves, electromagnetic waves, etc., and spread through electrical cables, optical cables or air. Physical media used for carrier waves, such as electrical cables, wireless connections or optical cables, can also be considered as media for carrying software. Unless the usage here is limited to tangible “storage” media, other terms referring to computer or machine “readable media” refer to media that participate in the execution of any instructions by a processor.

Specific examples are applied in the present disclosure, but the above description only sets forth the principle and implementation of the present disclosure, and the description of the above embodiments is only used to help understand the method of the present disclosure and the core idea thereof. It should be understood by those skilled in the art that the above-mentioned modules or steps of the present disclosure can be implemented by a general computer device, or alternatively, they can be implemented by program codes executable by the computing device, so that they can be stored in a storage device and executed by the computing device, or they can be made into individual integrated circuit modules, or a plurality of the modules or steps can be made into a single integrated circuit module. The present disclosure is not limited to any particular combination of hardware and software.

Further, for those skilled in the art, according to the idea of the present disclosure, there will be changes in the specific implementation and application scope. In summary, the contents of this specification should not be construed as limiting the present disclosure.

1. An optimized design method for carbon dioxide geological storage parameters of a depleted gas reservoir, which is used to optimize well pattern parameters and injection parameters during carbon dioxide injection and comprises following steps:
(1) collecting geological interpretation information, rock data, fluid properties and actual development data of the depleted gas reservoir in which carbon dioxide geological storage is to be carried out, and establishing a numerical simulation model of the depleted gas reservoir;
(2) carrying out fitting of production performance history of the depleted gas reservoir to obtain current state information of the depleted gas reservoir;
(3) simulating and predicting production performance data after carbon dioxide injection into depleted oil and gas reservoirs under different combinations of well pattern parameters and injection parameters through using a numerical simulation technology, comprising:
calculating the production performance data under combinations of well pattern parameters and injection parameters, the production performance data comprising a change of pressure with time, and a carbon dioxide storage amount, the storage amount being a sum of a structural storage amount, a residual phase storage amount, a dissolution storage amount and a mineralization storage amount, wherein the well pattern parameters determine whether existing wells in the depleted gas reservoir are used as injection wells in a carbon dioxide injection process without additional cost, that is, without adding new wells, and the injection parameters comprise an injection mode, a gas injection rate of each well, a water injection rate of each well and intermittent injection time;
(4) calculating a parameter value representing a uniform pressure rise according to the production performance data, comprising:
calculating a pressure value of each grid in a model at a final time step to obtain an average pressure value of the model at the time step, and calculating a standard deviation between the pressure value of each grid and the average pressure value of the model to obtain a standard pressure difference of the model at the time step, so as to obtain the parameter value representing the uniform pressure rise at the time step, which is a parameter value representing a uniform pressure rise of the depleted was reservoir, wherein
the average pressure value of the model at the time step is calculated by using a following formula
$$\overline{{P}_{n}} = {{\sum }^{a , b , c}}_{i = 1 , j = 1 , k = 1} {P}_{i , j , k}$$
where a is a number of grids in an i-th direction, b is a number of grids in a j-th direction, c is a number of grids in a k-th direction, P_{i, j, k} is a pressure value of each grid in the model, and P̅ₙ̅ is an average pressure value of the model at the time step;
the standard pressure difference of the model at the current time step is calculated by using a following formula:
$$S {D}_{n} = \sqrt{\frac{{{\sum }_{{i = 1 , j = 1 , k = 1}^{}}}^{a , b , c} {( {P}_{i , j , k} - \overline{{P}_{n}} )}^{2}}{m}}$$
where SDₙ is a standard pressure deviation of the model at the current time step and m is a number of grids in the model;
(5) updating the well pattern parameters and the injection parameters through using a genetic algorithm, comprising:
randomly generating a series of combinations of well pattern parameters and injection parameters within a range of constraints, obtaining objective function values corresponding to all combinations of parameters using the numerical simulation model, and initializing a population through each combination of well pattern parameters and injection parameters and an objective function value corresponding to each combination to obtain a parent population,
wherein an objective function is the parameter value representing the uniform pressure rise of the depleted gas reservoir; a combination of well pattern parameters and injection parameters comprises on-off state, gas injection rate, water injection rate, well opening time and well closing time of each well; the constraints comprise a 0-1 constraint on the on-off state of each well, upper and lower limit constraints on the gas injection rate, the water injection rate, the well opening time and the well closing time, and a constraint that gas injection is stopped when a formation pressure reaches a pressure threshold, which is 80% of a rock fracture pressure; and
obtaining a new offspring after subjecting the parent population to crossover and mutation, calculating a fitness function of individuals in the offspring by using the numerical simulation model, the fitness function using the parameter value representing the uniform pressure rise of the depleted gas reservoir, comparing fitness function values of individuals in the parent population and the individuals in the offspring, and updating the parent population to obtain a new parent population;
(6) repeating steps (3)-(5) until an iterative convergence condition is met; and
(7) determining an optimal combination of carbon dioxide injection process parameters according to an output optimal target value.

2. The optimized design method according to claim 1, wherein the collecting geological interpretation information, rock data, fluid properties and actual development data in step (1) comprises:
collecting geological interpretation information, comprising single well development data, single well stratification data, well logging curves, division of sedimentary facies, seismic data, seismic level data and fault data;
collecting rock data, comprising reservoir lithology, mineral composition, pore type, cementation type, porosity and permeability physical properties, sensitivity and rock compressibility;
collecting fluid properties, comprising formation fluid component content, crude oil density, viscosity, dissolved gas-oil ratio and other high-pressure physical properties, density, viscosity and PVT properties of gas components, complete analysis data of formation water quality, oil-water/oil-gas/gas-liquid relative permeability curves; and
collecting actual development data, comprising formation temperature, formation pressure distribution, development timetable, daily oil production, daily gas production, daily water production and bottom hole flowing pressure report.

3. The optimized design method according to claim 1, wherein the carrying out fitting of production performance history of the depleted gas reservoir to obtain current state information of the depleted gas reservoir in step (2) comprises:
setting a working system for each well in the depleted gas reservoir according to production data, fitting actual production data of oil production, gas production, water production and bottom hole flowing pressure; and outputting the current state information of the depleted gas reservoir after fitting, comprising an oil/gas/water saturation field, pressure distribution and temperature distribution.

4. (canceled)

5. (canceled)

6. (canceled)

7. The optimized design method according to claim 1, wherein the repeating steps (3)-(5) until an iterative convergence condition is met in step (6) comprises:
repeating steps (3)-(5) if the iterative convergence condition is not met; and ending calculation and proceeding to step (7) if the iterative convergence condition is met, wherein the iterative convergence condition is a maximum number of iterations of the algorithm, that is, a maximum number of operations of the numerical simulation model.

8. The optimized design method according to claim 1, wherein the determining an optimal combination of carbon dioxide injection process parameters according to an output optimal target value in step (7) comprises:
after the iterative convergence condition is met, outputting an individual with a global optimal target value, and obtaining the on-off state, the gas injection rate, the water injection rate, the well opening time and the well closing time of each well through decoding, wherein a combination of above parameters is the optimal combination of carbon dioxide injection process parameters. [5]

9. An optimized design system for carbon dioxide geological storage parameters of a depleted gas reservoir, which is used for the optimized design method according to claim 1, and comprises:
a collecting module, comprising:
a collecting sub-module, configured to collect geological interpretation information, rock data, fluid properties and actual development data of the depleted gas reservoir in which carbon dioxide geological storage is to be carried out, wherein the geological interpretation information comprises single well development data, single well stratification data, well logging curves, division of sedimentary facies, seismic data, seismic level data and fault data; the rock data comprises reservoir lithology, mineral composition, pore type, cementation type, porosity and permeability physical properties, sensitivity and rock compressibility; the fluid properties comprise formation fluid component content, crude oil density, viscosity, dissolved gas-oil ratio and other high-pressure physical properties, density, viscosity and PVT properties of gas components, complete analysis data of formation water quality, oil-water/oil-gas/gas-liquid relative permeability curves; the actual development data comprises formation temperature, formation pressure distribution, development timetable, daily oil production, daily gas production, daily water production and bottom hole flowing pressure report;
a building sub-module, configured to establish a numerical simulation model of the depleted gas reservoir;
an obtaining module, comprising:
a history fitting sub-module, configured to carry out fitting of production performance history of the depleted gas reservoir, wherein the fitting of production performance history comprises fitting the actual production data of oil production, gas production, water production and bottom hole flowing pressure;
an obtaining sub-module, configured to obtain current state information of the depleted gas reservoir, wherein the current state information of the depleted gas reservoir comprises an oil/gas/water saturation field, pressure distribution and temperature distribution;
a predicting module, configured to simulate and predict production performance data after carbon dioxide injection into depleted oil and gas reservoirs under different combinations of well pattern parameters and injection parameters through using the numerical simulation technology, wherein the production performance data comprises a change of pressure with time, and a carbon dioxide storage amount, in which the storage amount being a sum of a structural storage amount, a residual phase storage amount, a dissolution storage amount and a mineralization storage amount;
a calculating module, configured to calculate a parameter value representing a uniform pressure rise according to the production performance data;
an updating module, configured to update the well pattern parameters and the injection parameters through using a genetic algorithm;
an iteration module, configured to iteratively calculate a parameter value representing a uniform pressure rise under different combinations of parameters until an iterative convergence condition is met; and
a determining module, configured to determine an optimal combination of carbon dioxide injection process parameters.

10. The optimized design system according to claim 9, wherein the collecting geological interpretation information, rock data, fluid properties and actual development data in step (1) comprises:
collecting geological interpretation information, comprising single well development data, single well stratification data, well logging curves, division of sedimentary facies, seismic data, seismic level data and fault data;
collecting rock data, comprising reservoir lithology, mineral composition, pore type, cementation type, porosity and permeability physical properties, sensitivity and rock compressibility;
collecting fluid properties, comprising formation fluid component content, crude oil density, viscosity, dissolved gas-oil ratio and other high-pressure physical properties, density, viscosity and PVT properties of gas components, complete analysis data of formation water quality, oil-water/oil-gas/gas-liquid relative permeability curves; and
collecting actual development data, comprising formation temperature, formation pressure distribution, development timetable, daily oil production, daily gas production, daily water production and bottom hole flowing pressure report.

11. The optimized design system according to claim 9, wherein the carrying out fitting of production performance history of the depleted gas reservoir to obtain current state information of the depleted gas reservoir in step (2) comprises:
setting a working system for each well in the depleted gas reservoir according to production data, fitting actual production data of oil production, gas production, water production and bottom hole flowing pressure; and outputting the current state information of the depleted gas reservoir after fitting, comprising an oil/gas/water saturation field, pressure distribution and temperature distribution.

12. (canceled)

13. (canceled)

14. (canceled)

15. The optimized design system according to claim 9, wherein the repeating steps (3)-(5) until an iterative convergence condition is met in step (6) comprises:
repeating steps (3)-(5) if the iterative convergence condition is not met; and ending calculation and proceeding to step (7) if the iterative convergence condition is met, wherein the iterative convergence condition is a maximum number of iterations of the algorithm, that is, a maximum number of operations of the numerical simulation model.

16. The optimized design system according to claim 9, wherein the determining an optimal combination of carbon dioxide injection process parameters according to an output optimal target value in step (7) comprises:
after the iterative convergence condition is met, outputting an individual with a global optimal target value, and obtaining the on-off state, the gas injection rate, the water injection rate, the well opening time and the well closing time of each well through decoding, wherein a combination of above parameters is the optimal combination of carbon dioxide injection process parameters.
